(19) United States
(12) Patent Application Publication
(10) Pub. No.: US 2010/0017192 A1
(43) Pub. Date: Jan. 21, 2010

(54) Method and portable apparatus for performing spoken language translation using language areas of intended recipients' brain

(76) Inventor: Johnson("Johnson") Manuel-Devadoss ("Smith"), Chennai (IN)

Correspondence Address: Johnson Manuel-Devadoss ("Johnson Smith"), #03-276B, 4100 Clinton Drive, Houston, TX, 77020, US

(21) Appl. No.: 12/567,752

(22) Filed: Sep. 26, 2009

(51) Int. Cl. G06F 17/28

(52) U.S. Cl. 704/3

(57) ABSTRACT

In a portable unit, a method for performing spoken language translation using intended recipients' brain language areas. An input unit converts an acoustic waveform consisting of alternating high and low air pressure travelling through the air into an analogue electrical signal. The converted analogue signal fed into a speech recognition circuitry to identity the phonemes from an analogue signal. An interface is made between speech recognition circuitry and parser in terms of phoneme hypothesis and word hypothesis levels, so that prediction made by the parser can be immediately fed back to the speech recognition circuitry. The phoneme and word hypotheses given to the parser consist of several competitive phoneme or word hypotheses each of which are assigned the probability of being correct. The method also includes the steps of translating a speech in one language to a language native to another which is understandable by the language area of intended recipients' brain. The present invention discloses a method to identify the target language intended recipients' by using intended recipients' brain language areas.

### FIELD OF THE INVENTION

The present invention relates to a spoken language translation portable device, and more particularly, to a spoken language translation apparatus capable of translating a speech in one language to a language native to another which is understandable by the language areas such as Left and Right hemispheres of intended recipients' brain.

### BACKGROUND OF THE INVENTION

Languages are mankind's principle tools for interacting expressing ideas, emotions, knowledge, memories and values. Languages are also primary vehicles of cultural expressions and intangible cultural heritage, essential to the identity of individuals and groups. Safeguarding endangered languages is a crucial task in maintaining cultural diversity worldwide. Most individuals living in the United States read, write, speak, and understand English. There are many individuals, however, for whom English is not their primary language. The 2000 census shows that 26 million individuals speak Spanish and almost 7 million individuals speak an Asian or Pacific Island language at home. If these individuals have a limited ability to read, write, speak, or understand English, they are limited English proficient, or “Limited English Proficiency.” In a 2001 Supplementary Survey by the U.S. Census Bureau, 33% of Spanish speakers and 22.4% of all Asian and Pacific Island language speakers aged 18-64 reported that they spoke English either “not well” or “not at all.”

Patients from under developing countries seeking medical care always need to be accompanied with human translators to explain their medical problems and also to understand physician's advice. According to a report, more language interpretation services are needed in Connecticut's hospitals, doctors' offices and other health-care facilities to provide adequate medical care to patients with limited English skills. For example, The Connecticut Health Foundation, a nonprofit group based in New Britain, found that used of language interpretation services in medical settings throughout the state is limited, resulting in problems such as misdiagnosis and patient misunderstandings about doctors' instructions. The report advocated that hospitals and other health-care providers work toward providing more face-to-face interpretation services. Most of those with limited English skills speak Spanish, although the study found patients needing interpretation services in up to 65 different languages.

The study focused on low-income patients covered by Medicare whose main language is not English because Medicare will reimburse up to half the cost of interpretation services. The state's share of providing interpreters to the 22,000 Medicare recipients who need it would be about $2.35 million annually, according to the study. Results from a survey of leading physician organizations, medical groups and other health care associations in California suggest that nearly half (48%) of the 293 respondents knew of an instance in which a patient's limited English proficiency impacted his or her quality of care. The three biggest complaints were difficulty of history talking, wrong diagnosis and a general frustration with the lack of nuance in physician-patient communication with patients who have Limited English Proficiency (LEP).

In recent times, the number of people traveling to various countries for the purpose of pleasure and/or business has increased. People in different parts of the world generally communicate in different languages. During such travels, a traveler may face communication problems if he/she is not conversant in a language spoken in the part of the world he/she is visiting.

In order to overcome such communication problems, a traveler may use a human interpreter, a language translation book (for example, foreign language phrase books), or a combination of similar tools. However, human interpreters are usually very costly; while the translation books are cumbersome and do not allow for speedy translation.

Therefore to overcome all the above language barriers, there is a need for a system to perform automatic translation of speech wherein when one speaks in a native language others are able to comprehend in their own native languages without human interpreters, language translation books.

The following U.S. patents are hereby incorporated by reference for their teaching of language translation systems and methods: U.S. Pat. No. 6,356,865, issued to Franz et al., entitled “Method and apparatus for performing spoken language translation”; U.S. Pat. No. 5,758,023, issued to Bordeaux, entitled “Multi-language speech recognition system”; U.S. Pat. No. 5,293,584, issued to Brown et al., entitled “Speech recognition system for natural language translation”; U.S. Pat. No. 5,963,892, issued to Tanaka et al., entitled “Translation apparatus and method for facilitating speech input operation and obtaining correct translation thereof”; U.S. Pat. No. 7,162,412, issued to Yamada et al., entitled “Multilingual conversation assist system”; U.S. Pat. No. 6,917,920, issued to Koizumi et al., entitled “Speech translation device and computer readable medium”; U.S. Pat. No. 4,984,177/issued to Rondel et al., entitled “Voice language translators; and U.S. Pat. No. 4,507,750, issued to Frantz et al., entitled “Electronic apparatus from a host language”; U.S. Pat. No. 7,593,842, issued to Rousseau et al., entitled “Device and method for translating language”; U.S. Pat. No. 5,293,584, issued to Peter F. Brown et al., entitled “Speech recognition system for natural language translation”; U.S. Pat. No. 5,963,892, issued to Miyuki Tanaka et al., “Translation apparatus and method for facilitating speech input operation and obtaining correct translation thereof”.

U.S. patent application Ser. No. 12/543,054, filed Aug. 18, 2009, assigned to the same assignee as the instant application, incorporated herein by reference.

Although there have been many advances in system and software for providing language translation to users interested in communicating in a language other than their own, there has not been an apparatus or method that facilitate to identify intended recipients' natural language using intended recipients' brain's language area. Accordingly, the present inventor has developed a hand-held device that can identify the intended recipients' natural language by their brain language area as target language for speech translation.

### SUMMARY OF THE INVENTION

Typically, communication is said to be successful between two people if someone speaks and opponent party can understand. In other words the intended recipient's brain language area can comprehend the speech. The problem of not understanding the speech of others is the cause of language barriers. So, this invention discloses a method to solve the language barrier problem where it is capable of interpreting meaning of speech in one language to a language native to another—basically to a language the recipient brain can comprehend.

Speech translation is basically converting to a language that the language area of recipient human brain can understand. Recipient(s) may not be able to comprehend the speech because their brain language area is not tuned to understand the spoken language. In medical terms, it is called “Wernicke's Aphasia”.

According to DiscoveryChannel.ca report, by using electrodes attached to a person's face and neck, the device detects the electrical signals sent to the person's facial muscles and tongue when specific words are mouthed. The software is able to decode the information into phonemes—the building blocks of words. Since there are only 45 different phonemes used in English, the system is able to predict what phonemes are most likely to appear next to each other. This helps the device translate phrases even if it hasn't heard them before. The system won't help make peace with any hostile aliens just yet, though . . . . It only translates correctly with 62 percent efficiency when faced with a phrase for the first time.

The present invention discloses a method to identify the target language by using intended recipients' brain language areas. The language area of human brain is called “Wernicke” which is nothing but a neuron in human brain capable to interpret words that we hear or read and several temporoparietal regions are used for language comprehension along with Wernicke's area. Wernicke then relays this information via a dense bundle of fibers to Broca's area that generates words that we speak in response. Wernicke's area, temporoparietal regions and frontal lobes together have all the language comprehensive information needed for understanding speech.

The main object of the present invention is to provide language translation system that is capable of providing a translation of speech in one language to a language native to another which is understandable by the language areas (i.e., left and right hemispheres) of the recipients' brain.

All these put together with other aspects of the present invention, along with the various features that describe the present invention, especially those pointed out in the claims section form a part of the present invention. To gain more knowledge of the present invention understanding of the drawings attached and the detailed description is highly essential.

### BRIEF DESCRIPTION OF THE DRAWINGS

FIG. 1 illustrates the prior art of speech translation device of the present invention.

FIG. 2 illustrates a processing flow of the present invention.

FIG. 3 is a partially schematic, isometric illustration of a human brain illustrating areas associated with language comprehension.

### DETAILED DESCRIPTION OF THE INVENTION

Reference will now be made in detail to the preferred embodiments of the present invention, examples of which are illustrated in the accompanying drawings, wherein like reference numerals refer to like elements throughout.

Communication is said to be effective between two people, if one speaks and opponent party can understand. In other words the intended recipients' brain language area can comprehend the words/sentence/speech. The present invention basically does that—interpreting meaning of word(s) in a language understandable by Wernicke's area and temporoparietal regions of intended recipient brain.

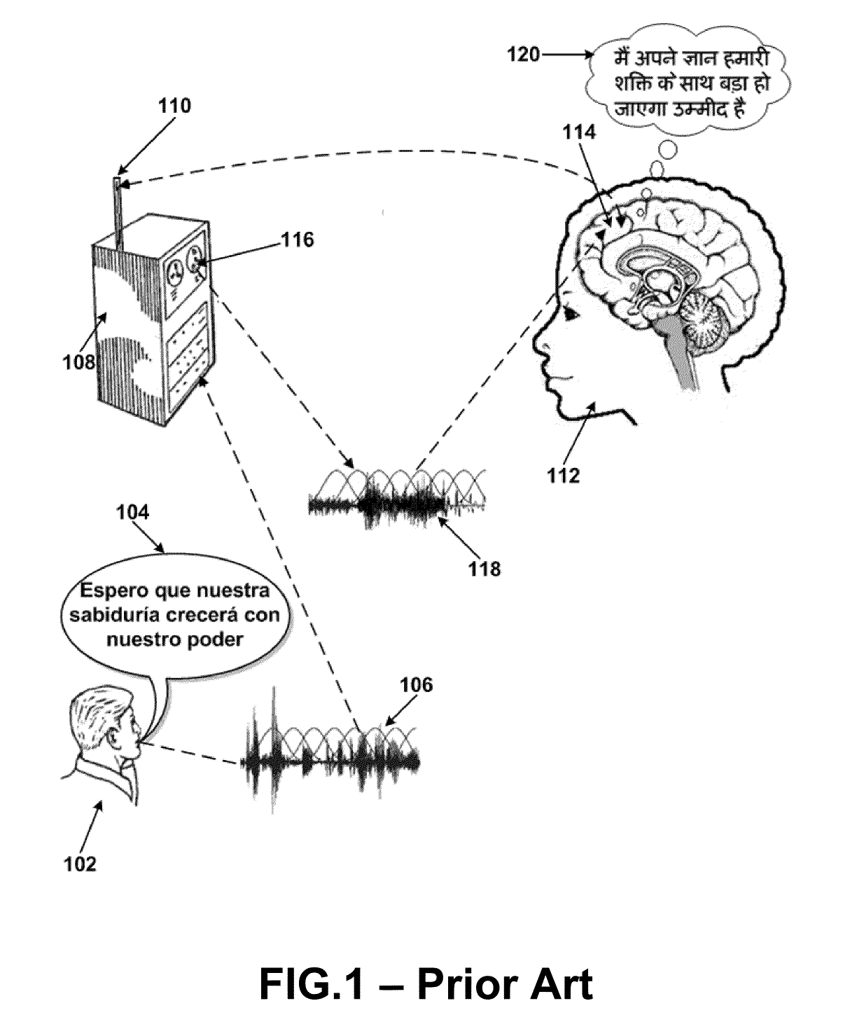

FIG. 1 illustrates a broad structure of the present invention. The spoken words 104 of man 102 travels through air as vocalized form. The spoken words of man 102 in Spanish Language 104 contain the syntactic combination of lexicals and names that are drawn from very large vocabularies. Each spoken word of man 102 is created out of the phonetic combination of a limited set of vowel and consonant speech sound units and travels over air as an acoustic waveform 106. The property of spoken voice is determined by the rate of vibration of the vocal cords. The greater number of vibrations per second, the higher the pitch. The rate of vibration, in turn, is determined by the length and thickness of the vocal cords and by the tightening or relaxation of these cords. A spoken language translation hand-held device 108 of present invention receives an acoustic waveform that consisting of alternating high and low air pressure travelling through the air and converts into the electromagnetic signal.

The speech signals are broken down into recognizable phonemes which make up the most basic elements of speech in spoken language, such as Spanish, of a man. The sequentially generated phonemes identified from the speech signals are then regrouped so as to form recognizable words in Spanish Language that are spoken by man. Sentences are then formed using the grammatical rules of the Spanish language so that each sentence may be translated into a woman's 112 natural language. A woman's 112 natural language identified by using her brain language areas. A hand-held device broadcasts an electromagnetic radiation directed towards the woman's 112 head to collect an evaluation of the state of the language areas' structure and also the degree of stress it is experiencing. The antenna of hand-held device receives the electromagnetic frequencies which contain a rapid analysis of the language areas, such as Wernicke's area, temporoparietal regions, and Broca's area, of brain 114 of woman 112.

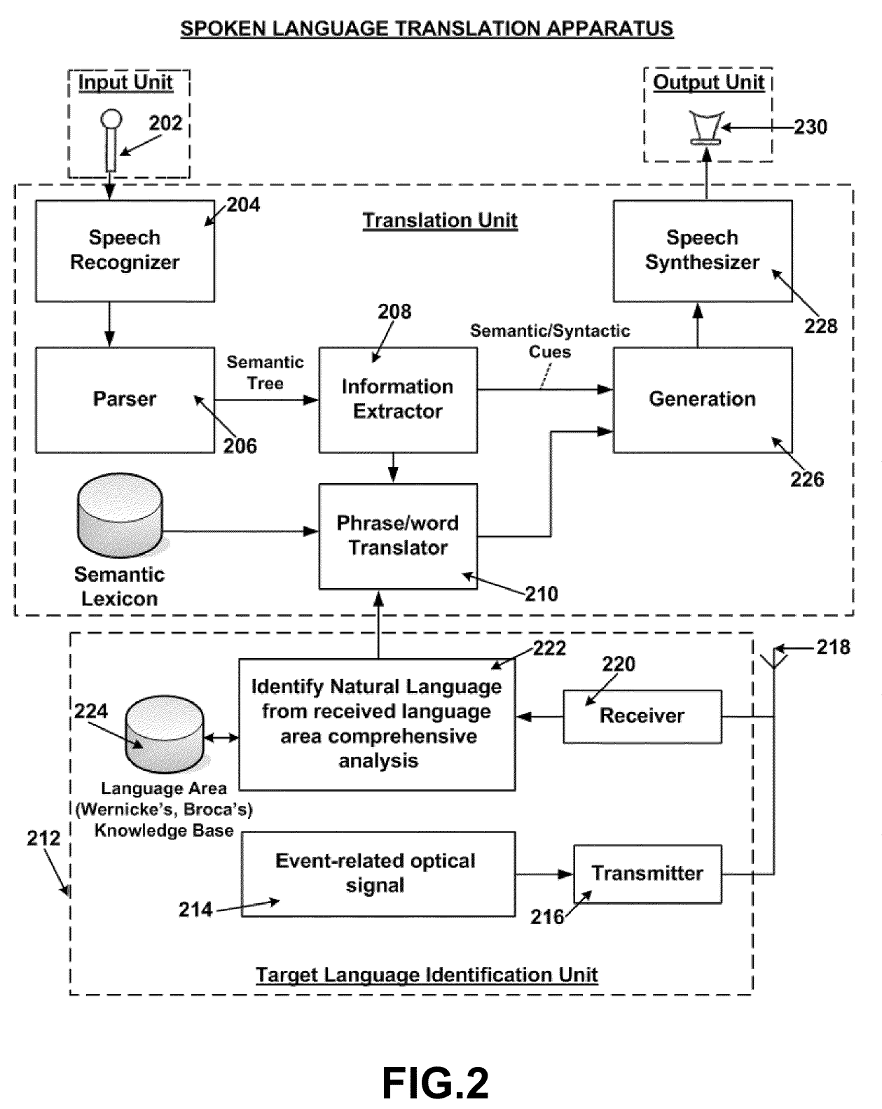

The analysis of the language areas of brain 114 of woman 112 then compared with language areas knowledge base 224 (shown in FIG. 2) to identify a natural language of woman 112. The language area knowledge base 224 (shown in FIG. 2) is an exhaustive, comprehensive, obsessively massive list of samples of language area information; wherein said list of samples are the collected information from experimental test results data of brain's language areas Wernicke's area, temporoparietal regions, and Broca's area and collected information from neurologists about brain's language areas comprehension. Thus, the natural language (i.e., “Hindi”) of woman 112 derived from language area knowledge base 224 (shown in FIG. 2) and then fed into translation unit to generate the corresponding words in “Hindi” language for spoken sentence in Spanish 104 of man 102. The generated sentence in Hindi language then fed into Speech Synthesizer to generate an audio signal. The speech synthesizer provides the audio input of Hindi language sentence to output unit, such as speaker, of a hand-held device. Thus, the language areas (Wernicke's/Broca's areas) of brain 114 of woman 112 comprehends the spoken sentence 104 of a man 102 by hearing the acoustic waveform 118 on air which produced by speaker of hand-held device.

As shown in FIG. 2, an Input unit 202, such as microphone, operatively coupled to the present invention of spoken language translation apparatus. An input unit receives and converts an acoustic waveform consisting of alternating high and low air pressure travelling through the air into the analog signal. The analog signal fed into a speech recognition unit 204 to identify the phoneme-level sequences from analog signal. The Speech Recognition unit 204 is capable of receiving continuous speech information and converting the speech into machine recognizable phonemes. Such a system is disclosed in U.S. Pat. No. 4,852,170 issued Jul. 25, 1989 to Theodore A. Bordeaux made of record and incorporated herein by reference. The speech recognition circuitry 3 also includes a spectrum analyzer to remove background noise as disclosed by European Patent 570,660 published Nov. 24, 1993, by Peter F. Brown et al.

The phoneme sequence contains substitution, insertion and deletion of phonemes, as compared to a correct transcription which contains only expected phonemes. The task of parser 206 is to activate a hypothesis as to the correct phoneme sequence from the noisy phoneme sequence. The accurate translation from speech input done by sophisticated parsing and generation 226 units. The present invention comprises the parser 206 and generation 208 units. It is capable of interpreting the elliptical, ill-formed sentences that appear in speech signal. An interface is made between Speech Recognition unit 204 and parser 206 in terms of phoneme hypothesis and word hypothesis levels, so that prediction made by the parser can be immediately fed back to the Speech Recognition unit. Thus, phoneme and word hypotheses given to the parser consist of several competitive phoneme or word hypotheses each of which are assigned the probability of being correct. With this mechanism, the accuracy of recognition can be improved because it filters out false first choices of the speech recognition and selects grammatically and semantically plausible second or third best hypotheses. The parser 206 is capable of handling multiple hypotheses in a parallel rather than a single word sequence as seen in text input machine translation systems. A generation unit 226 is capable of generating appropriate sentences with correct articulation control.

The natural language (target language) of intended recipient determined by identifying brain's language areas such as Right/Left hemispheres (i.e., Wernicke's, temporoparietal regions, and Broca's areas) of intended recipient. The present invention of spoken language translation apparatus makes use of transmitter 216 and antenna 218 to broadcast electromagnetic radiation directed towards the intended recipient's head. The rapid analysis of the language areas such as Right/Left hemispheres of intended recipient's brain, are analyzed within seconds to provide an evaluation of the state of the cell's structure. Only information, not energy, is exchanged. The present invention of language translation system discloses an Event-related optical signal 214 (EROS) brain-scanning technique which uses infrared light through optical fibers to measure changes in optical properties of active areas of the Language Areas. EROS takes advantage of the scattering properties of the neurons themselves, and thus provides a much more direct measure of cellular (Wernicke's area, temporoparietal regions, and Broca's area) activity. Such a system is disclosed in Physioscan, where Physioscan is a computer-operated system and uses the electromagnetic radiation to provide a rapid analysis of the energy in the body's organs and tissues.

The antenna 218 of present invention of spoken language translation apparatus receives the electromagnetic frequencies which contain a rapid analysis of the language areas such as Right/Left hemispheres of intended recipient's brain. The receiver 220 of present invention of spoken language translation apparatus receives an electromagnetic signal from antenna and then fed into natural language identification unit 222. The analysis of the language areas of intended recipient's brain then compared with language area knowledge base 224 to identify a natural language of intended recipient. The language area knowledge base 224 is an exhaustive, comprehensive, obsessively massive list of samples of language area information; wherein said list of samples are the collected information from experimental test results data of brain's language areas such as Wernicke's, temporoparietal regions, and Broca's areas and collected information from neurologists about brain's language areas comprehension. The identified natural language fed into translation unit to translate a speech in one language to a language native to the intended recipient. The translated sentences in natural language of intended recipient fed into speech synthesizer 228 and then deliver the speech signal through output unit 230.

In human beings, it is the left hemisphere that usually contains the specialized language areas. While this holds true for 97% of right-handed people, about 19% of left-handed people have their language areas in the right hemisphere and as many as 68% of them have some language abilities in both the left and the right hemisphere. Both the two hemispheres are thought to contribute to the processing and understanding of language: the left hemisphere processes the linguistic of prosody, while the right hemisphere processes the emotions conveyed by prosody.

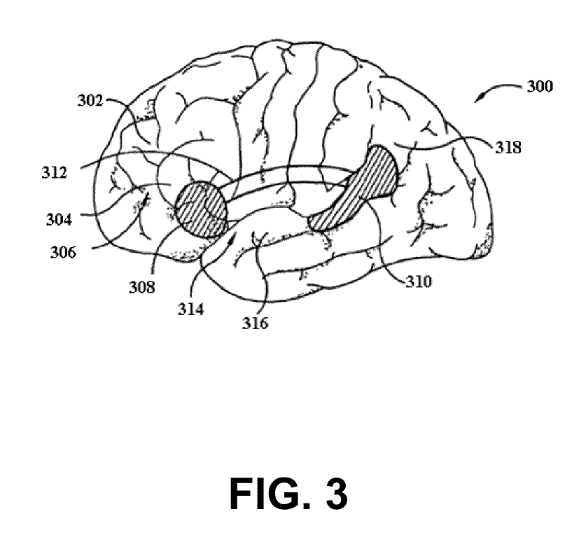

FIG. 3 is an isometric, left side view of the brain 300. The targeted language areas of the brain 300 can include Broca's area 308 and/or Wernicke's area 310. Sections of the brain 300 anterior to, posterior to, or between these areas can be targeted in addition to Broca's area 308 and Wernicke's area 310. For example, the targeted areas can include the middle frontal gyrus 302, the inferior frontal gyrus 304 and/or the inferior frontal lobe 306 anterior to Broca's area 308. The other areas targeted for stimulation can include the superior temporal lobe 314, the superior temporal gyrus 316, and/or the association fibers of the arcuate fasciculus 312, the inferior parietal lobe 318 and/or other structures, including the supramarginal gyrus, angular gyrus, retrosplenial cortex and/or the retrosplenial cuneus of the brain 300.

The first language area is called Wernicke's area 310. Wernicke's area 310 is an area in the posterior temporal lobe of the left hemisphere of the brain involved in the recognition of spoken words. Wernicke's area 310 one of the two parts of the cerebral cortex linked since the late nineteenth century to speech. It is traditionally considered to consist of the posterior section of the superior temporal gyrus in the dominant cerebral hemisphere (which is the left hemisphere in about 90% of people).The second language area within the left hemisphere is called Broca's area 308. The Broca's area 308 is an area located in the frontal lobe usually of the left cerebral hemisphere and associated with the motor control of speech. The Broca's area 308 doesn't just handle getting language out in a motor sense it is more generally involved in the ability to deal with grammar itself, at least the more complex aspects of grammar.

By analyzing data from numerous brain-imaging experiments, researchers have now distinguished three sub-areas within Wernicke's area 310. The first sub-area responds to spoken words (including the individual's own) and other sounds. The second sub-area responds only to words spoken by someone else but is also activated when the individual recalls a list of words. The third sub-area is more closely associated with producing speech than with perceiving it. All of these findings are still compatible, however, the general role of Wernicke's area 310, relates to the representation of phonetic sequences, regardless of whether the individual hears them, generates them, or recalls them from memory.

As described above, the present invention discloses a method and portal apparatus for translating a speech in one language to a language native to the intended recipient(s). Accordingly, the present invention discloses a system of comprehending native languages without the use of any hand-held translators. This invention employs a system where there will no longer be a need to learn new language. Effective communication is now feasible between people speaking different languages. This system explores the capabilities of the human brain and utilizes the language information of the brain and performs the automatic translation in the background. It should be noted that with all the reading of language area of the human brain—the human brain will not be affected or caused any harm during this process.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application. Although the present invention has been described with reference to particular embodiments, it will be apparent to those skilled in the art that variations and modifications can be substituted without departing from the principles and spirit of the invention.

Thus the scope of the invention should be determined by the appended claims and their legal equivalents, rather than by the examples given.

I claim:

1. A spoken language translation apparatus to translate a speech originating from a source into a speech that can be understood by other entities' brain language areas, said the spoken language translation apparatus comprising:
an input unit operatively integrated with said a spoken language translation apparatus to convert an acoustic waveform that consisting of alternating high and low air pressure travelling through the air into an analogue signal;
a speech recognition unit connected to said audio input for converting any speech within the input speech signal into recognizable phonemes;
a parser unit operatively connected to speech recognition unit to activate a hypothesis as to the correct phoneme sequence from the elliptical, ill-formed sentences that are appeared in the speech;
a generation unit integrated with said spoken language translation apparatus in order to generate the most specific expressions using past cases and their generalization, while maintaining syntactic coverage of the generator.
a speech synthesizer connected to said output of said generation unit so as to broadcast audible speech which is the translation of said spoken words in said target language.

2. The spoken language translation apparatus of claim 1, wherein said the originating source is a human being.

3. The spoken language translation apparatus of claim 1, wherein said the other entities are human beings.

4. The spoken language translation apparatus of claim 1, wherein said the brain language areas are nerve cells in a human being brain's Left hemisphere and Right hemisphere;
wherein said Right hemisphere is the Wernicke's areas;
wherein said Wernicke's areas are the regions in the posterior temporal lobe of the left hemisphere of the brain involved in the recognition of spoken words;
wherein said Left hemisphere is the Broca's areas;
wherein said Broca's areas are the regions located in the frontal lobe usually of the left cerebral hemisphere and associated with the motor control of speech.

5. The spoken language translation apparatus of claim 1 further comprising the target language identification unit, the target language of intended recipients' identified by broadcasting electromagnetic radiation towards intended recipients' head to collect rapid analysis of said language areas. The collected analysis compared with language area knowledge base to derive the natural language of plurality of intended recipient,
wherein said intended recipients are human beings who are in the audible range of said speech originating from source.

6. The method of claim 5, wherein said language area knowledge base is an exhaustive, comprehensive, obsessively massive list of samples of language area information; wherein said list of samples are the collected information from experimental test results data of brain's language areas said brain's language areas Wernicke's area, temporoparietal regions, and Broca's area and collected information from neurologists about brain's language areas comprehension.

7. A method to identify the target language of plurality of recipient by using plurality of recipient's said brain language areas, wherein said recipient is a human being, said method comprising the steps of:
identifying speech elements by generating a consecutive number of recognizable phonemes of the speech contained within the audio signal from the spoken speech;
forming consecutive words by grouping the consecutive number of recognizable phonemes into recognizable consecutive words;
forming consecutive sentences by grouping the recognizable consecutive words formed in said step of identifying the natural language, and forming said consecutive words into sentences in accordance with grammatical rules of the natural language of the speech identified;
identifying the said intended recipients' natural language by collecting said the rapid analysis of language areas said Wernicke's/Broca's of brain of intended recipients' and comparing them with said language area knowledge base;
translating into the intended recipient's natural language; and
broadcasting said each translated language sentence with a speech synthesizer to the intended recipient.
